(19) United States
(12) Patent Application Publication
(10) Pub. No.: US 2009/0123629 A1
(43) Pub. Date: May 14, 2009

(54) Tofu Hydrated Structured Protein Compositions

(75) Inventors: Michael Chin An Chang, Seoul (KR); Colleen Trater, Glen Carbon, IL (US)

Correspondence Address: Solae, LLC, 4300 Duncan Avenue, Legal Department E4, St. Louis, MO, 63110, US

(73) Assignee: SOLAE, LLC, St. Louis, MO (US)

(21) Appl. No.: 12/184,983

(22) Filed: Aug. 1, 2008

Related U.S. Application Data
(60) Provisional application No. 60/953,252, filed on Aug. 1, 2007.

(51) Int. Cl. A23J 3/16; A23L 1/05; A23L 1/29

(52) U.S. Cl. 426/573; 426/634; 426/656; 426/643; 426/644; 426/647; 426/646; 426/519

(57) ABSTRACT

The present invention discloses a structured protein composition which includes a structured protein product which can be combined with tofu, soy whey, or soymilk and a coagulant to form the structured protein composition. Restructured meat compositions and restructured food compositions which include the structured protein composition are also included.

### CROSS REFERENCE TO RELATED APPLICATIONS

This application claims priority from U.S. Provisional Application Ser. No. 60/953,252 filed on Aug. 1, 2007, which is hereby incorporated by reference in its entirety.

### FIELD OF THE INVENTION

The present invention provides hydrated structured protein compositions and the processes used to produce them. In particular, the hydrated structured protein compositions comprise a structured protein product comprising protein fibers that are substantially aligned and tofu, and may be combined with meat.

### BACKGROUND OF THE INVENTION

All types of tofu, silken and firm for example, are manufactured for primarily retail sale to high physical quality standards. Tofu that is not Grade A due to negative physical characteristics, like a corner of the curd being chipped in the package, currently is not being used in value added products that include other types of protein. This tofu can be used to hydrate structured protein ingredients. Use of tofu would maintain or augment eating quality of products made with the structured protein products hydrated with water.

### SUMMARY OF THE INVENTION

One aspect of the invention encompasses a hydrated structured protein food composition which is formed by combining a structured protein product and tofu. The tofu is mixed with the structured protein product in order to hydrate the structured protein product and form a hydrated structured protein composition.

Another aspect of the invention encompasses a hydrated structured protein composition prepared by combining a structured protein product and soymilk, then adding a coagulant to form a hydrated structured protein composition with coagulated protein dispersed within the structured protein product.

A further aspect of the invention encompasses a process of making a hydrated structured protein composition comprising the steps of mixing a structured protein product with soymilk, and adding a coagulant to form a hydrated structured protein composition. Additionally, soy whey can be used to hydrate the structured protein product.

Another aspect of the invention encompasses a hydrated structured protein composition prepared by combining a structured protein product with water and then combining the structured protein product with tofu.

The hydrated structured protein composition can be used to prepare meat-free products, such as vegetarian burgers and other meat analogs along with vegetarian food products. The hydrated structured protein composition can also be combined with meat to prepare a wide variety of food products. Further, the hydrated structured protein can be combined with a comminuted vegetable or comminuted fruit to produce various food products.

Other aspects and features of the invention are described in more detail below.

### REFERENCE TO COLOR FIGURES

The application contains at least one photograph executed in color. Copies of this patent application publication with color photographs will be provided by the Office upon request and payment of the necessary fee.

### FIGURE LEGENDS

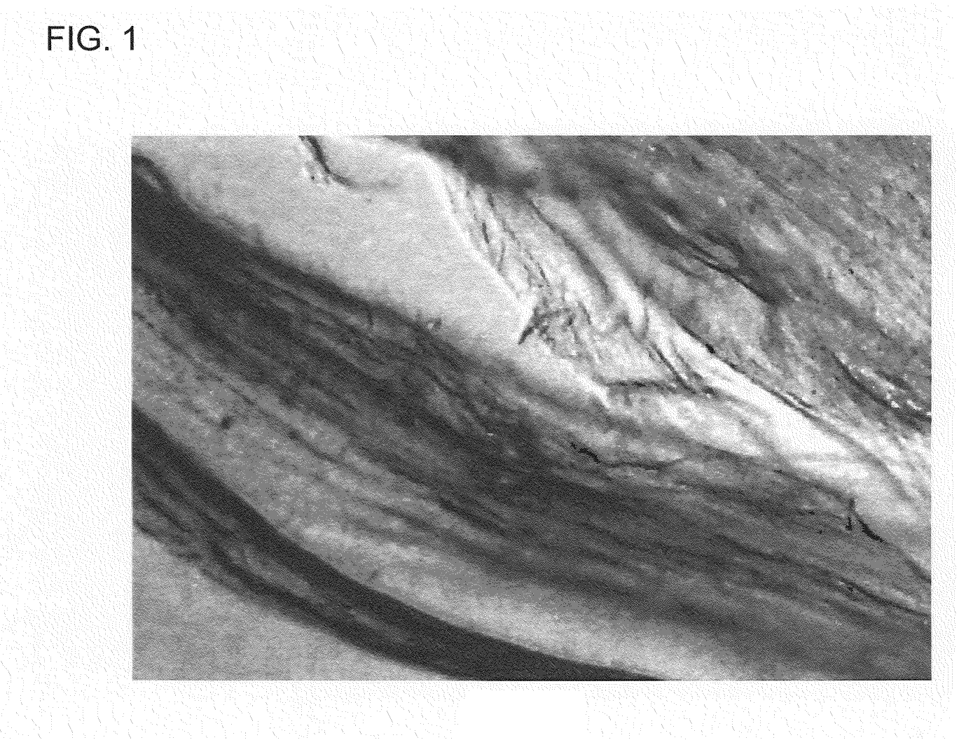

FIG. 1 depicts an image of a micrograph showing a structured protein product of the invention having protein fibers that are substantially aligned.

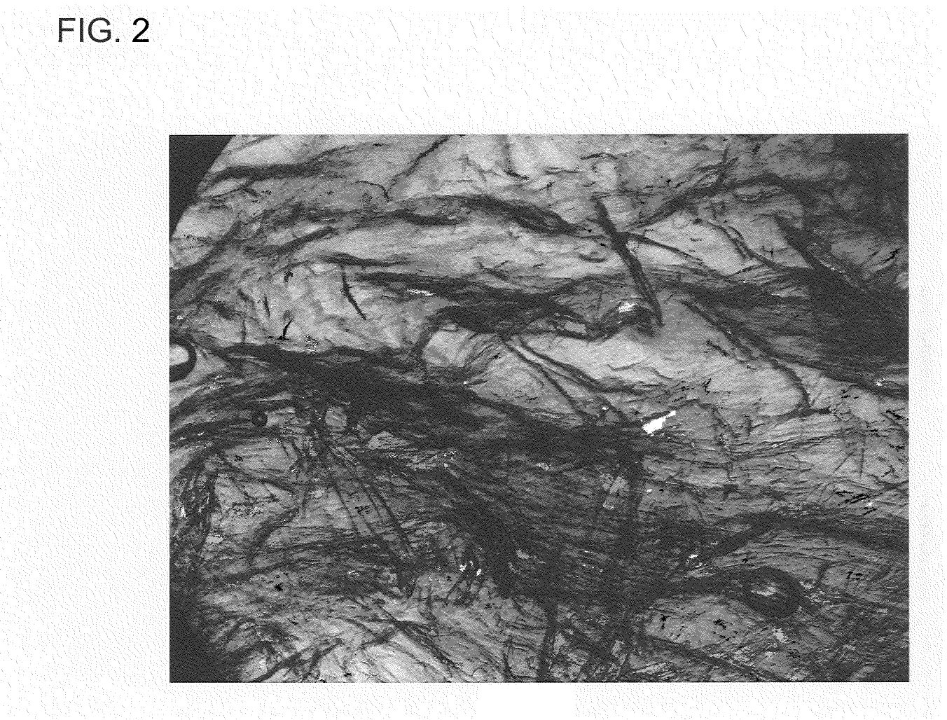

FIG. 2 depicts an image of a micrograph showing a protein product not produced by the process of the present invention. The protein fibers comprising the protein product, as described herein, are crosshatched.

### DETAILED DESCRIPTION OF THE INVENTION

The present invention provides hydrated structured protein compositions and processes for producing hydrated structured protein compositions. Typically, the hydrated structured protein composition will comprise tofu and structured protein products having protein fibers that are substantially aligned. Alternatively, the hydrated structured protein composition will comprise structured protein products having protein fibers that are substantially aligned, soymilk, and a coagulant. In another embodiment, the structured protein product is a structured protein isolate, a structured protein concentrate, a structured protein flour, or mixtures thereof. The composition can be used in combination with a comminuted vegetable or comminuted fruit to produce various food products. Typically, the composition is combined with meat to form a meat food product or used without meat to create either a meat analog food product or vegetarian food product.

### (I) Structured Protein Products

The hydrated structured protein compositions of the invention comprise structured protein products comprising protein fibers that are substantially aligned, as described in more detail in I (e) below. In an exemplary embodiment, the structured protein products are extrudates of protein material that have been subjected to the extrusion process detailed in I(d) below. Because the structured protein products comprise protein fibers that are substantially aligned in a manner similar to animal meat, the hydrated structured vegetable protein compositions of the invention generally have the texture and eating quality characteristics similar to those of animal meat while providing an improved nutritional profile (i.e. higher percentage of protein and lower percentages of both fat and cholesterol).

(a) Protein-Containing Materials

The protein-containing material may be derived from a variety of sources. Irrespective of its source or ingredient classification, the ingredients utilized in the extrusion process are typically capable of forming structured protein products having protein fibers that are substantially aligned. Suitable examples of such ingredients are detailed more fully below.

A variety of ingredients that contain protein may be utilized in a thermo plastic extrusion process to produce structured protein products suitable for use in food products. While ingredients comprising proteins derived from plants are typically used, it is also envisioned that proteins derived from other sources, such as animal sources, may be utilized without departing from the scope of the invention. For example, a dairy protein selected from the group consisting of casein, caseinates, whey protein, and mixtures thereof may be utilized. In an exemplary embodiment, the dairy protein is whey protein. By way of further example, an egg protein selected from the group consisting of ovalbumin, ovoglobulin, ovomucin, ovomucoid, ovotransferrin, ovovitella, ovovitellin, albumin globulin, vitellin, and combinations thereof may be utilized. Further, meat proteins or protein ingredients consisting of collagen, blood, organ meat, mechanically separated meat, partially defatted tissue, blood serum proteins and combinations thereof may be included as one or more of the ingredients of the structured protein products.

It is envisioned that other ingredient types in addition to proteins may be utilized. Non-limiting examples of such ingredients include sugars, starches, oligosaccharides, soy fiber, other dietary fibers, gluten, and combinations thereof.

While in some embodiments gluten may be used as a protein ingredient, it is also envisioned that the structured protein product may be gluten-free. Further, it is envisioned that the structured protein product may be wheat-free. Because gluten is typically used in filament formation during the extrusion process, an edible crosslinking agent may be utilized to facilitate filament formation when the structured protein product is devoid of gluten or a wheat protein source. Non-limiting examples of suitable crosslinking agents include L-cysteine, transglutaminase, calcium salts, magnesium salts, and combinations thereof. One skilled in the art can readily determine the amount of cross linking material needed, if any, in gluten-free embodiments.

(i) Plant Protein Materials

In an exemplary embodiment, at least one ingredient derived from a plant will be utilized to form the structured protein product. Generally speaking, the ingredient will comprise a protein. The protein-containing material derived from a plant may be a plant meal, a plant-derived flour, a plant protein isolate, a plant protein concentrate, or combinations thereof. The amount of protein present in the ingredient(s) utilized can and will vary depending upon the application. For example, the amount of protein present in the ingredient(s) utilized may range from about 40% to about 100% by weight. In another embodiment, the amount of protein present in the ingredient(s) utilized may range from about 50% to about 100% by weight. In an additional embodiment, the amount of protein present in the ingredient(s) utilized may range from about 60% to about 100% by weight. In a further embodiment, the amount of protein present in the ingredient(s) utilized may range from about 70% to about 100% by weight. In still another embodiment, the amount of protein present in the ingredient(s) utilized may range from about 80% to about 100% by weight. In a further embodiment, the amount of protein present in the ingredient(s) utilized may range from about 90% to about 100% by weight.

The ingredient(s) utilized in extrusion may be derived from a variety of suitable plants. The plants may be grown conventionally or organically. By way of non-limiting examples, suitable plants include amaranth, arrowroot, barley, buckwheat, cassaya, canola, channa (garbanzo), corn, kamut, legume, lentil, lupin, millet, oat, pea, peanut, potato, quinoa, rape, rice, rye, sorghum, sunflower, tapioca, triticale, wheat, and mixtures thereof. Exemplary plants include soy, wheat, canola, corn, legume, lupin, oat, pea, potato, and rice.

In one embodiment, the ingredients are isolated from wheat and soybeans. In another exemplary embodiment, the ingredients are isolated from soybeans. In a further embodiment, the ingredients are isolated from wheat. Suitable wheat derived protein-containing ingredients include wheat gluten, wheat flour, and mixtures thereof. Examples of commercially available wheat gluten that may be utilized in the invention include Manildra Gem of the West Vital Wheat Gluten and Manildra Gem of the West Organic Vital Wheat Gluten each of which is available from Manildra Milling Corporation (Shawnee Mission, Kans.). Suitable soy derived protein-containing ingredients (“soy protein material”) include soy protein isolate, soy protein concentrate, soy flour, and mixtures thereof, each of which are detailed below. In each of the foregoing embodiments, the soybean material may be combined with one or more ingredients selected from the group consisting of a starch, flour, gluten, a dietary fiber, and mixtures thereof.

Suitable examples of protein-containing material isolated from a variety of sources are detailed in Table A, which shows various combinations.

TABLE A
Protein Combinations

| First Protein Source | Second Ingredient |
|---|---|
| Soybean | Wheat |
| Soybean | Dairy |
| Soybean | Egg |
| Soybean | Corn |
| Soybean | Rice |
| Soybean | Barley |
| Soybean | Sorghum |
| Soybean | Oat |
| Soybean | Millet |
| Soybean | Rye |
| Soybean | Triticale |
| Soybean | Buckwheat |
| Soybean | Pea |
| Soybean | Peanut |
| Soybean | Lentil |
| Soybean | Lupin |
| Soybean | Channa (garbonzo) |
| Soybean | Canola |
| Soybean | Cassava |
| Soybean | Sunflower |
| Soybean | Whey |
| Soybean | Tapioca |
| Soybean | Arrowroot |
| Soybean | Amaranth |
| Soybean | Potato |
| Soybean | Wheat and dairy |
| Soybean | Wheat and egg |
| Soybean | Wheat and corn |
| Soybean | Wheat and rice |
| Soybean | Wheat and barley |
| Soybean | Wheat and sorghum |
| Soybean | Wheat and oat |
| Soybean | Wheat and millet |
| Soybean | Wheat and rye |
| Soybean | Wheat and triticale |
| Soybean | Wheat and buckwheat |
| Soybean | Wheat and pea |
| Soybean | Wheat and peanut |
| Soybean | Wheat and lentil |
| Soybean | Wheat and lupin |
| Soybean | Wheat and channa (garbonzo) |
| Soybean | Wheat and canola |
| Soybean | Wheat and cassava |
| Soybean | Wheat and sunflower |
| Soybean | Wheat and potato |
| Soybean | Wheat and tapioca |
| Soybean | Wheat and arrowroot |
| Soybean | Wheat and amaranth |
| Soybean | Wheat and whey |
| Soybean | Canola and corn |
| Soybean | Canola and lupin |
| Soybean | Canola and oat |
| Soybean | Canola and pea |
| Soybean | Canola and rice |
| Soybean | Canola and sorghum |
| Soybean | Canola and amaranth |
| Soybean | Canola and arrowroot |
| Soybean | Canola and barley |
| Soybean | Canola and buckwheat |
| Soybean | Canola and cassava |
| Soybean | Canola and channa (garbanzo) |
| Soybean | Canola and millet |
| Soybean | Canola and peanut |
| Soybean | Canola and rye |
| Soybean | Canola and potato |
| Soybean | Canola and sunflower |
| Soybean | Canola and tapioca |
| Soybean | Canola and triticale |
| Soybean | Canola and dairy |
| Soybean | Canola and whey |
| Soybean | Canola and egg |
| Soybean | Corn and whey |
| Soybean | Corn and dairy |
| Soybean | Corn and egg |
| Soybean | Corn and rice |
| Soybean | Corn and barley |
| Soybean | Corn and sorghum |
| Soybean | Corn and oat |
| Soybean | Corn and millet |
| Soybean | Corn and rye |
| Soybean | Corn and triticale |
| Soybean | Corn and buckwheat |
| Soybean | Corn and pea |
| Soybean | Corn and peanut |
| Soybean | Corn and lentil |
| Soybean | Corn and lupin |
| Soybean | Corn and channa (garbonzo) |
| Soybean | Corn and cassava |
| Soybean | Corn and sunflower |
| Soybean | Corn and potato |
| Soybean | Corn and tapioca |
| Soybean | Corn and arrowroot |
| Soybean | Corn and amaranth |

In each of the embodiments delineated in Table A, the combination of protein-containing materials may be combined with one or more ingredients selected from the group consisting of a starch, flour, gluten, dietary fiber, and mixtures thereof. In one embodiment, the protein-containing material comprises protein, starch, gluten, and fiber. In an exemplary embodiment, the protein-containing material comprises from about 45% to about 65% soy protein on a dry matter basis; from about 20% to about 30% wheat gluten on a dry matter basis; from about 10% to about 15% wheat starch on a dry matter basis; and from about 1% to about 5% fiber on a dry matter basis. In each of the foregoing embodiments, the protein-containing material may comprise dicalcium phosphate, L-cysteine or combinations of both dicalcium phosphate and L-cysteine.

(ii). Soy Protein Materials

In an exemplary embodiment, as detailed above, soy protein isolate, soy protein concentrate, soy flour, and mixtures thereof may be utilized in the extrusion process. The soy protein materials may be derived from whole soybeans in accordance with methods generally known in the art. The whole soybeans may be commoditized soybeans (i.e., non-genetically modified soybeans), organic soybeans, identity preserved soybeans, genetically modified soybeans, and combinations thereof.

In one embodiment, the soy protein material may be an isolated soy protein (ISP). In general, an isolated soy protein has a protein content of at least about 90% soy protein on a moisture-free basis. Generally speaking, when isolated soy protein is used, an isolate is preferably selected that is not a highly hydrolyzed isolated soy protein. In certain embodiments, highly hydrolyzed isolated soy proteins, however, may be used in combination with other isolated soy proteins provided that the highly hydrolyzed isolated soy protein content of the combined isolated soy proteins is generally less than about 40% of the combined isolated soy protein, by weight. Additionally, the isolated soy protein utilized preferably has an emulsion strength and gel strength sufficient to enable the protein in the isolate to form fibers that are substantially aligned upon extrusion. Examples of soy protein isolates that are useful in the present invention are commercially available, for example, from Solae, LLC (St. Louis, Mo.), and include SUPRO® 500E, and SUPRO® EX 33.

Alternatively, soy protein concentrate may be blended with the isolated soy protein to substitute for a portion of the isolated soy protein as a source of soy protein material. Typically, if a soy protein concentrate is substituted for a portion of the isolated soy protein, the soy protein concentrate is substituted for up to about 55% of the isolated soy protein by weight. The soy protein concentrate can be substituted for up to about 50% of the soy protein isolate by weight. It is also possible in an embodiment to substitute 40% by weight of the soy protein concentrate for the soy protein isolate. In another embodiment, the amount of soy protein concentrate substituted is for up to about 30% of the soy protein isolate by weight. Examples of suitable soy protein concentrates useful in the invention include ALPHA™ DSP-C, Procon™ 2000, ALPHA™ 12 and ALPHA™ 5800, which are commercially available from Solae, LLC (St. Louis, Mo.).

If soy flour is substituted for a portion of the soy protein isolate, the soy flour is substituted for up to about 35% of the soy protein isolate by weight. The soy flour should be a high protein dispersibility index (PDI) soy flour. When soy flour is used, the starting material is preferably a defatted soybean flour or flakes. Full fat soybeans contain approximately 40% protein by weight and approximately 20% oil by weight. These whole full fat soybeans may be defatted through conventional processes when a defatted soy flour or flakes form the starting protein material. For example, the bean may be cleaned, dehulled, cracked, passed through a series of flaking rolls and then subjected to solvent extraction by use of hexane or other appropriate solvents to extract the oil and produce “spent flakes”, The defatted flakes may be ground to produce a defatted soy flour. Although the process is yet to be employed with full fat soy flour, it is believed that full fat soy flour may also serve as a protein source. However, where full fat soy flour is processed, it is most likely necessary to use a separation step, such as three-stage centrifugation to remove oil. In yet another embodiment, the soy protein material may be defatted soy flour, which has a protein content of about 49% to about 650% on a moisture-free basis. Alternatively, soy flour may be blended with soy protein isolate or soy protein concentrate.

(iii) Fiber Materials

Any food fiber material known in the art can be used as the fiber source in the invention. Soy cotyledon fiber may optionally be utilized as a fiber source. Typically, suitable soy cotyledon fiber will generally effectively bind water when the mixture of soy protein and soy cotyledon fiber is co-extruded. In this context, “effectively bind water” generally means that the soy cotyledon fiber has a water holding capacity of at least 5.0 to about 8.0 grams of water per gram of soy cotyledon fiber, and preferably the soy cotyledon fiber has a water holding capacity of at least about 6.0 to about 8.0 grams of water per gram of soy cotyledon fiber. When present in the soy protein material, soy cotyledon fiber may generally be present in the soy protein material in an amount ranging from about 1% to about 20%, preferably from about 1.5% to about 20% and most preferably, at from about 2% to about 5% by weight on a moisture free basis. Suitable soy cotyledon fiber is commercially available. For example, FIBRIM® 1260 and FIBRIM® 2000 are soy cotyledon fiber materials that are commercially available from Solae, LLC (St. Louis, Mo.).

(iv) Animal Protein Materials

A variety of animal meats are suitable as protein sources for use in the structured protein composition. Animals from which the meat is obtained may be raised conventionally or organically. By way of example, meat and meat ingredients defined specifically for the various structured vegetable protein patents include intact or ground beef, pork, lamb, mutton, horsemeat, goat meat, meat, fat and skin of poultry (domestic fowl such as chicken, duck, goose or turkey) and more specifically flesh tissues from any fowl (any bird species), fish flesh derived from both fresh and salt water fish, animal flesh of shellfish and crustacean origin, animal flesh trim and animal tissues derived from processing such as frozen residue from sawing frozen fish, chicken, beef, pork etc., chicken skin, pork skin, fish skin, animal fats such as beef fat, pork fat, lamb fat, chicken fat, turkey fat, rendered animal fat such as lard and tallow, flavor enhanced animal fats, fractionated or further processed animal fat tissue, finely textured beef, finely textured pork, finely textured lamb, finely textured chicken, low temperature rendered animal tissues such as low temperature rendered beef and low temperature rendered pork, mechanically separated meat or mechanically deboned meat (MDM) (meat flesh removed from bone by various mechanical means) such as mechanically separated beef, mechanically separated pork, mechanically separated fish including surimi, mechanically separated chicken, mechanically separated turkey, any cooked animal flesh and organ meats derived from any animal species, and combinations thereof. Meat flesh should be extended to include muscle protein fractions derived from salt fractionation of the animal tissues, protein ingredients derived from isoelectric fractionation and precipitation of animal muscle or meat and hot boned meat as well as mechanically prepared collagen tissues and gelatin. Additionally, meat, fat, connective tissue and organ meats of game animals such as buffalo, deer, elk, moose, reindeer, caribou, antelope, rabbit, bear, squirrel, beaver, muskrat, opossum, raccoon, armadillo and porcupine as well as reptilian creatures such as snakes, turtles and lizards, and combinations thereof should be considered meat.

In a further embodiment, the animal meat may be from fish or seafood. Non-limiting examples of suitable fish include bass, carp, catfish, cobia, cod, grouper, flounder, haddock, hoki, perch, pollock, salmon, snapper, sole, trout, tuna, whitefish, whiting, tilapia, and combinations thereof. Non-limiting examples of seafood include scallops, shrimp, lobster, clams, crabs, mussels, oysters, and combinations thereof.

It is also envisioned that a variety of meat qualities may be utilized in the invention. The meat may comprise muscle tissue, organ tissue, connective tissue, skin, and combinations thereof. The meat may be any animal flesh suitable for human consumption. The meat may be non-rendered, non-dried, raw meat, raw meat products, raw meat by-products, and mixtures thereof. For example, whole muscle meat that is either ground or in chunk or steak form may be utilized. In another embodiment, the meat may be mechanically deboned or separated raw meats formed using high-pressure machinery that separates bone from animal tissue, by first crushing bone and adhering animal tissue and then forcing the animal tissue, and not the bone, through a sieve or similar screening device. The process forms an unstructured, paste-like blend of soft animal tissue with a batter-like consistency; this material is commonly referred to as mechanically deboned meat or MDM. In an additional embodiment, seafood meat can be obtained through typical MDM processes or any method known in the art for separating seafood meat, such as fish or shellfish from bones or shells. Alternatively, the meat may be a meat by-product. In the context of the present invention, the term “meat by-products” is intended to refer to those non-rendered parts of the carcass of slaughtered animals, fish, and shellfish. Examples of meat by-products are organs and tissues such as lungs, spleens, kidneys, brains, livers, blood materials, bones, partially defatted low-temperature fatty tissues, stomachs, intestines free of their contents, and the like.

The protein source may also be an animal derived protein other than animal flesh. For example, the protein-containing material may be derived from a dairy product. Suitable dairy protein products include non-fat dried milk powder, whole milk powder, milk protein isolate, milk protein concentrate, casein protein isolate, casein protein concentrate, caseinates, whey protein isolate, whey protein concentrate, and combinations thereof. The milk protein-containing material may be derived from cows, goats, sheep, donkeys, camels, camelids, yaks, or water buffalos. In an exemplary embodiment, the dairy protein is whey protein.

By way of further example, a protein-containing material may also be from an egg product. Suitable egg protein products include powdered egg, dried egg solids, dried egg white protein, liquid egg white protein, egg white protein powder, isolated ovalbumin protein, and combinations thereof. Examples of suitable isolated egg proteins include ovalbumin, ovoglobulin, ovomucin, ovomucoid, ovotransferrin, ovovitella, ovovitellin, albumin globulin, vitellin, and combinations thereof. Egg protein products may be derived from the eggs of chicken, duck, goose, quail, or other birds.

(v) Combinations of Protein-Containing Materials

Non-limiting combinations of protein-containing materials isolated from a variety of sources are detailed in Table A. In one embodiment, the protein-containing material is derived from soybeans. In a preferred embodiment, the protein-containing material comprises a mixture of materials derived from soybeans and wheat. In another preferred embodiment, the protein-containing material comprises a mixture of materials derived from soybeans and canola. In still another preferred embodiment, the protein-containing material comprises a mixture of materials derived from soybeans, wheat, and dairy, wherein the dairy protein is whey.

(vi) pH Regulators

The protein-containing materials may further comprise a pH regulator to maintain the pH in order to obtain the desired texture for a specific end use. The pH regulator may be an acidulant that reduces food pH. Examples of acidulants that may be added to food include citric acid, acetic acid (vinegar), tartaric acid, malic acid, fumaric acid, lactic acid, phosphoric acid, sorbic acid, benzoic acid, and combinations thereof. The concentration of the pH regulator utilized may vary depending on the protein-containing materials and the colorant used. Typically, the concentration of pH regulator may range from about 0.001% to about 5.0% by weight. In one embodiment, the concentration of pH regulator may range from about 0.01% to about 4.0% by weight. In another embodiment, the concentration of pH regulator may range from about 0.05% to about 3.0% by weight. In still another embodiment, the concentration of pH regulator may range from about 0.1% to about 3.0% by weight. In a further embodiment, the concentration of pH regulator may range from about 0.5% to about 2.0% by weight. In another embodiment, the concentration of pH regulator may range from about 0.75% to about 1.0% by weight. In an alternative embodiment, the pH regulator may be a pH-raising agent, such as disodium diphosphate.

In some embodiments, it may be desirable to adjust the pH of the protein-containing material to an acidic pH (i.e., below approximately 7.0) in order to obtain the desired texture. Thus, the protein-containing material may be contacted with a pH-lowering agent, and the mixture is then extruded according to the process detailed below. In one embodiment, the pH of the protein-containing material to be extruded may range from about 6.0 to about 7.0. In another embodiment, the pH may range from about 5.0 to about 6.0. In an alternate embodiment, the pH may range from about 4.0 to about 5.0. In yet another embodiment, the pH of the material may be less than about 4.0.

Several pH-lowering agents are suitable for use in the invention. The pH-lowering agent may be an organic acid. Alternatively, the pH-lowering agent may be an inorganic acid. In exemplary embodiments, the pH-lowering agent is a food grade edible acid. Non-limiting acids suitable for use in the invention include acetic, lactic, hydrochloric, phosphoric, citric, tartaric, malic, and combinations thereof. In an exemplary embodiment, the pH-lowering agent is lactic acid.

As will be appreciated by a skilled artisan, the amount of pH-lowering agent contacted with the protein-containing material can and will vary depending upon several parameters, including, the agent selected, concentration, and the desired pH. In one embodiment, the amount of pH-lowering agent may range from about 0.1% to about 15% on a dry matter basis. In another embodiment, the amount of pH-lowering agent may range from about 0.5% to about 10% on a dry matter basis. In an alternate embodiment, the amount of pH-lowering agent may range from about 1% to about 5% on a dry matter basis. In still another embodiment, the amount of pH-lowering agent may range from about 2% to about 3% on a dry matter basis.

In some embodiments, it may be desirable to raise the pH of the protein-containing material. Thus, the protein-containing material may be contacted with a pH-raising agent, and the mixture is then extruded according to the process detailed below.

(b) Additional Ingredients

It is envisioned that other ingredient additives in addition to proteins may be utilized in the structured protein products. Non-limiting examples of such ingredients include sugars, starches, oligosaccharides, and dietary fibers. As an example, starches may be derived from wheat, corn, tapioca, potato, rice, and the like. A suitable fiber source may be soy cotyledon fiber. Typically, suitable soy cotyledon fiber will generally effectively bind water when the mixture of soy protein and soy cotyledon fiber is co-extruded. In this context, “effectively bind water” generally means that the soy cotyledon fiber has a water holding capacity of at least 5.0 to about 8.0 grams of water per gram of soy cotyledon fiber, and preferably the soy cotyledon fiber has a water holding capacity of at least about 6.0 to about 8.0 grams of water per gram of soy cotyledon fiber. Soy cotyledon fiber may generally be present in the soy protein material in an amount ranging from about 1% to about 20% by weight on a moisture free basis, preferably from about 1.5% to about 20% by weight on a moisture free basis, and most preferably, at from about 2% to about 5% by weight on a moisture free basis. Suitable soy cotyledon fiber is commercially available. For example, FIBRIM® 1260 and FIBRIM® 2000 are soy cotyledon fiber materials that are commercially available from Solae, LLC (St. Louis, Mo.).

One or more antioxidants may be added to any of the combinations of protein-containing materials detailed above without departing from the scope of the invention. Antioxidants may be included to increase the shelf-life or nutritionally enhance the structured protein products. Non-limiting examples of suitable antioxidants include BHA, BHT, TBHQ, vitamins A, C and E and derivatives, various plant extracts, such as those containing carotenoids, tocopherols or flavonoids having antioxidant properties, and combinations thereof. The antioxidants may have a presence at levels of from about 0.001% to about 10%, preferably, from about 0.001% to about 5%, and more preferably from about 0.001% to about 2%, by weight of the protein-containing materials that will be extruded.

The protein-containing material may also optionally include supplemental minerals. Suitable minerals may include one or more minerals or mineral sources. Non-limiting examples of minerals include, chloride, sodium, calcium, iron, chromium, copper, iodine, zinc, magnesium, manganese, molybdenum, phosphorus, potassium, selenium, and combinations thereof. Suitable forms of any of the foregoing minerals include soluble mineral salts, slightly soluble mineral salts, insoluble mineral salts, chelated minerals, mineral complexes, non-reactive minerals such as carbonate minerals, reduced minerals, and combinations thereof.

Free amino acids may also be included in the protein-containing material. Suitable amino acids include the essential amino acids, i.e., arginine, cysteine, histidine, isoleucine, leucine, lysine, methionine, phenylalanine, threonine, tyrosine, tryptophan, valine, and combinations thereof. Suitable forms of the amino acids include both salts and chelates.

(c) Moisture Content

As will be appreciated by the skilled artisan, the moisture content of the protein-containing materials can and will vary depending upon the extrusion process. Generally speaking, the moisture content may range from about 1% to about 80% by weight. In low moisture extrusion applications, the moisture content of the protein-containing materials may range from about 1% to about 35% by weight. Alternatively, in high moisture extrusion applications, the moisture content of the protein-containing materials may range from about 35% to about 80% by weight. In an exemplary embodiment, the extrusion application utilized to form the extrudates is low moisture. An exemplary example of a low moisture extrusion process to produce extrudates having proteins with fibers that are substantially aligned is detailed in I(d).

(d) Extrusion of the Protein-Containing Material

A suitable extrusion process for the preparation of structured protein products comprises introducing the protein-containing material, and other ingredients into a mixing tank (i.e., an ingredient blender) to combine the ingredients and form a blended protein material pre-mix. The blended protein material pre-mix may be transferred to a hopper from which the blended ingredients may be introduced along with moisture into the extruder. In another embodiment, the blended protein material pre-mix may be combined with a conditioner to form a conditioned protein material mixture. The conditioned material may then be fed into an extruder in which the protein material mixture is heated under mechanical pressure generated by the screws of the extruder to form a molten extrusion mass. Alternatively, the blended protein material pre-mix may be directly fed to an extruder in which moisture and heat are introduced to from a molten extrusion mass. In a further embodiment, the ingredients can be fed in as separate streams to the pre-conditioner or extruder. The molten extrusion mass exits the extruder through an extrusion die forming an extrudate comprising structured protein products having protein fibers that are substantially aligned.

(i) Extrusion Process Conditions

Among the suitable extrusion apparatuses useful in the practice of the present invention is a double barrel, twin-screw extruder as described, for example, in U.S. Pat. No. 4,600,311. Further examples of suitable commercially available extrusion apparatuses include a CLEXTRAL® Model BC-72 extruder manufactured by Clextral, Inc. (Tampa, Fla.); a WENGER Model TX-57 extruder, a WENGER Model TX-168 extruder, and a WENGER Model TX-52 extruder all manufactured by Wenger Manufacturing, Inc. (Sabetha, Kans.). Other conventional extruders suitable for use in this invention are described, for example, in U.S. Pat. Nos. 4,763,569, 4,118,164, and 3,117,006, which are hereby incorporated by reference in their entirety.

A single-screw extruder could also be used in the present invention. Examples of suitable, commercially available single-screw extrusion apparatuses include the WENGER Model X-175, the WENGER Model X-165, and the WENGER Model X-85, all of which are available from Wenger Manufacturing, Inc.

The screws of a twin-screw extruder can rotate within the barrel in the same or opposite directions. Rotation of the screws in the same direction is referred to as single flow or co-rotating whereas rotation of the screws in opposite directions is referred to as double flow or counter rotating. The speed of the screw or screws of the extruder may vary depending on the particular apparatus; however, it is typically from about 250 to about 450 revolutions per minute (rpm). Generally, as the screw speed increases, the density of the extrudate will decrease. The extrusion apparatus contains screws assembled from shafts and worm segments, as well as mixing lobe and ring-type shearlock elements to increase mixing and shearing as recommended by the extrusion apparatus manufacturer for extruding plant protein material.

The extrusion apparatus generally comprises a plurality of heating zones through which the protein mixture is conveyed under mechanical pressure prior to exiting the extrusion apparatus through an extrusion die. In one embodiment, the conditioned pre-mix is transferred through four heating zones within the extrusion apparatus, with the protein mixture heated to a temperature of from about 100° C. to about 150° C. such that the molten extrusion mass enters the extrusion die at a temperature of from about 100° C. to about 150° C. One skilled in the art could adjust the temperature either heating or cooling to achieve the desired properties. Typically, temperature changes are due to work input and can happen suddenly. Thus, in order for the feed material to become a thermoplastic melt it may not be necessary to add heat to the apparatus since the combination of the thermal energy being put into the extrusion process as steam and the mechanical energy of the apparatus that is converted to thermal energy increases the temperature in the extrusion apparatus can be enough to convert the feed material into a thermoplastic melt.

The pressure within the extruder barrel is typically between about 50 psig to about 500 psig preferably between about 75 psig to about 200 psig. Generally, the pressure within the last two heating zones is from about 100 psig to about 3000 psig preferably between about 150 psig to about 500 psig. The barrel pressure is dependent on numerous factors including, for example, the extruder screw speed, feed rate of the mixture to the barrel, feed rate of water to the barrel, and the viscosity of the molten mass within the barrel, extruder barrel temperatures, and die design.

Water may be injected into the extruder barrel to hydrate the plant protein material mixture and promote texturization of the proteins. As an aid in forming the molten extrusion mass, the water may act as a plasticizing agent. Water may be introduced to the extruder barrel via one or more injection jets in communication with a heating zone. Typically, the mixture in the barrel contains from about 1% to about 35% water by weight. In one embodiment, the mixture in the barrel contains from about 5% to about 20% water by weight. The rate of introduction of water to any of the heating zones is generally controlled to promote production of an extrudate having desired characteristics. It has been observed that as the rate of introduction of water to the barrel decreases, the density of the extrudate decreases. Typically, less than about 1 kg of water per kg of protein is introduced to the barrel. Preferably, from about 0.1 kg to about 1 kg of water per kg of protein are introduced to the barrel.

(ii) Optional Preconditioning

In a pre-conditioner, the protein-containing material and other ingredients (protein-containing mixture) are preheated, contacted with moisture, and held under controlled temperature and pressure conditions to allow the moisture to penetrate and soften the individual particles. The preconditioning step increases the bulk density of the particulate fibrous material mixture and improves its flow characteristics. The preconditioner contains one or more shafts with paddles to promote uniform mixing of the protein and transfer of the protein mixture through the preconditioner. The configuration and rotational speed of the paddles vary widely, depending on the capacity and length of the preconditioner, the extruder throughput and/or the desired residence time of the mixture in the preconditioner or extruder barrel. Generally, the speed of the paddles is from about 100 to about 1300 revolutions per minute (rpm). Agitation must be high enough to obtain even hydration and good mixing.

Typically, the protein-containing mixture is pre-conditioned prior to introduction into the extrusion apparatus by contacting the pre-mix with moisture (i.e., steam and/or water). Preferably the protein-containing mixture is heated to a temperature of from about 25° C. to about 80° C., more preferably from about 30° C. to about 40° C. in the preconditioner.

Typically, the protein-containing pre-mix is conditioned for a period of about 0.5 minutes to about 10.0 minutes, depending on the speed and the size of the pre-conditioner. In an exemplary embodiment, the protein-containing pre-mix is conditioned for a period of about 3.0 minutes to about 5.0 minutes. In a further example, the period for conditioning is about 30.0 seconds to about 60.0 seconds. The pre-mix is contacted with steam and/or water and heated in the pre-conditioner at generally constant steam flow to achieve the desired temperatures. The water and/or steam conditions (i.e., hydrates) the pre-mix, increases its density, and facilitates the flowability of the dried mix without interference prior to introduction to the extruder barrel where the proteins are texturized. If low moisture pre-mix is desired, the conditioned pre-mix may contain from about 1% to about 35% (by weight) water. If high moisture pre-mix is desired, the conditioned pre-mix may contain from about 35% to about 80% (by weight) water.

The conditioned pre-mix typically has a bulk density of from about 0.25 g/cm³ to about 0.60 g/cm³. Generally, as the bulk density of the pre-conditioned protein mixture increases within this range, the protein mixture is easier to process. This is presently believed to be due to such mixtures occupying all or a majority of the space between the screws of the extruder, thereby facilitating conveying the extrusion mass through the barrel. It also improves the efficiency to generate more shear and pressure to texturize the molten and the extrusion mass.

(iii) Extrusion Process

The dry pre-mix or the conditioned pre-mix is then fed into an extruder to heat, shear, and ultimately plasticize the mixture. The extruder may be selected from any commercially available extruder and may be a single screw extruder or preferably a twin-screw extruder that mechanically shears the mixture with the screw elements.

The rate at which the pre-mix is generally introduced to the extrusion apparatus will vary depending upon the particular apparatus size and model. Generally, the pre-mix is introduced at a rate of no more than about 75 kilograms per minute. Generally, it has been observed that the density of the extrudate decreases as the feed rate of pre-mix to the extruder increases. Whatever extruder is used, it should be run in excess of about 50% motor load. The rate at which the pre-mix is generally introduced to the extrusion apparatus will vary depending upon the particular apparatus. Typically, the conditioned pre-mix is introduced to the extrusion apparatus at a rate of between about 16 kilograms per minute to about 60 kilograms per minute. In another embodiment, the conditioned pre-mix is introduced to the extrusion apparatus at a rate between 20 kilograms per minute to about 40 kilograms per minute. The conditioned pre-mix is introduced to the extrusion apparatus at a rate of between about 26 kilograms per minute to about 32 kilograms per minute. Generally, it has been observed that the density of the extrudate decreases as the feed rate of pre-mix to the extruder increases.

The pre-mix is subjected to shear and pressure by the extruder to plasticize the mixture. The extruder screw elements shear the mixture as well as generate pressure by forcing the mixture throughout the extruder barrel and die assembly. The screw speed along with the screw profile, temperature, and the die used determines the amount of shear and pressure applied to the mixture. Preferably, the screw speed is set from about 200 rpm to about 500 rpm, and more preferably from about 300 rpm to about 450 rpm, which moves the mixture through the extruder at a rate of at least about 20 kilograms per minute, and more preferably at least about 40 kilograms per minute. Preferably the extruder generates die pressure of from about 200 to about 3000 psig.

The extruder heats the mixture as it passes through the extruder further denaturing the protein in the mixture. Passing through the extruder the denatured protein is restructured or reconfigured to produce a structured protein material with protein fibers substantially aligned. The extruder includes a means for heating the mixture to temperatures of from about 100° C. to about 180° C. Preferably the means for heating the mixture in the extruder comprises extruder barrel jackets into which heating or cooling media such as steam or water may be introduced to control the temperature of the mixture passing through the extruder. The extruder also includes steam injection ports for directly injecting steam into the mixture within the extruder. The extruder may also include steam injection ports for directly injecting steam into the mixture within the extruder. While the extrudate temperature is mainly determined by the mechanical energy inputs as mentioned previously, the extruder can include multiple heating zones that can be controlled to independent temperatures, where the temperatures of the heating zones are preferably set to increase the temperature of the mixture as it proceeds through the extruder. In one embodiment, the extruder may be set in a four temperature zone arrangement, where the first zone (adjacent the extruder inlet port) is set to a temperature of from about 50° C. to about 80° C., the second zone is set to a temperature of from about 80° C. to 100° C., the third zone is set to a temperature of from 100° C. to about 130° C., and the fourth zone (adjacent the extruder exit port) is set to a temperature of from 130° C. to 150° C. The extruder may be set in other temperature zone arrangements, as desired. In another embodiment, the extruder may be set in a five temperature zone arrangement, where the first zone is set to a temperature of about 25° C., the second zone is set to a temperature of about 50° C., the third zone is set to a temperature of about 95° C., the fourth zone is set to a temperature of about 130° C., and the fifth zone is set to a temperature of about 150° C. In still another embodiment, the extruder may be set in a six temperature zone arrangement, where the first zone is set to a temperature of about 90° C., the second zone is set to a temperature of about 10° C., the third zone is set to a temperature of about 105° C., the fourth zone is set to a temperature of about 100° C., the fifth zone is set to a temperature of about 120° C., and the sixth zone is set to a temperature of about 130° C.

The mixture forms a melted plasticized mass in the extruder. A die assembly is attached to the extruder in an arrangement that permits the plasticized mixture to flow from the extruder exit port into the die assembly and produces substantial alignment of the protein fibers within the plasticized mixture as it flows through the die assembly. The die assembly may include a faceplate die, a peripheral die, an annular gap die, or any die assembly known in the art that will create substantially aligned fibers.

The width and height dimensions of the die aperture(s) are selected and set prior to extrusion of the mixture to provide the fibrous material extrudate with the desired dimensions. The width of the die aperture(s) may be set so that the extrudate resembles from a cubic chunk of meat to a steak filet, where widening the width of the die aperture(s) decreases the cubic chunk-like nature of the extrudate and increases the filet-like nature of the extrudate. Preferably the width of the die aperture(s) is/are set to a width of from about 5 millimeters to about 40 millimeters.

The height dimension of the die aperture(s) may be set to provide the desired thickness of the extrudate. The height of the aperture(s) may be set to provide a very thin extrudate or a thick extrudate. Preferably, the height of the die aperture(s) may be set to from about 1 millimeter to about 30 millimeters, and more preferably from about 8 millimeters to about 16 millimeters.

It is also contemplated that the die aperture(s) may be round. The diameter of the die aperture(s) may be set to provide the desired thickness of the extrudate. The diameter of the aperture(s) may be set to provide a very thin extrudate or a thick extrudate. Preferably, the diameter of the die aperture(s) may be set to from about 1 millimeter to about 30 millimeters, and more preferably from about 8 millimeters to about 16 millimeters.

Examples of peripheral die assemblies suitable for use in this invention to produce the structured protein fibers that are substantially aligned are described in U.S. Pat. App. No. 60/882,662, and U.S. patent application Ser. No. 11/964,538 and are hereby incorporated by reference in their entirety.

The extrudate may be cut after exiting the die assembly. Suitable apparatuses for cutting the extrudate include flexible knives for face die cutting and hard blades for peripheral cutting manufactured by Wenger Manufacturing, Inc. (Sabetha, Kans.) and Clextral, Inc. (Tampa, Fla.). Typically, the speed of the cutting apparatus is from about 100 rpm to about 4500 rpm. Ultimately, the speed of the cutting apparatus is determined by the desired length for the end use product. In an exemplary embodiment, the speed of the cutting apparatus is about 1200 rpm. A delayed cut can also be done to the extrudate. One such example of a delayed cut device is a guillotine device. The structured protein product as cut from the extruder can be further size reduced to prepare structured protein products of specific sizes and shapes. Equipment utilized for size reduction include any equipment known in the art for such purpose, such as Comitrol® model 2500 TranSlicer® cutter (Urschel Laboratories, Inc., Valparaiso, Ind.), Urschel M6 Dicer (Urschel Laboratories, Inc., Valparaiso, Ind.), Comitrol® Processor Model 2100 (Urschel Laboratories, Inc., Valparaiso, Ind.) and Fitzmill® (Elmhurst, Ill.).

The dryer, if one is used, generally comprises a plurality of drying zones in which the air temperature may vary. Examples known in the art include convection dryers. The extrudate will be present in the dryer for a time sufficient to produce an extrudate having the desired moisture content. Thus, the temperature of the air is not important; if a lower temperature is used (such as 50° C.) longer drying times will be required than if a higher temperature is used. Generally, the temperature of the air within one or more of the zones will be from about 135° C. to about 185° C. Suitable dryers include those manufactured by CPM Wolverine Proctor (Lexington, N.C.), National Drying Machinery Co. (Trevose, Pa.), Wenger (Sabetha, Kans.), Clextral (Tampa, Fla.), and Buehler (Lake Bluff, Ill.).

Another option is to use microwave assisted drying. In this embodiment, a combination of convective and microwave heating is used to dry the product to the desired moisture. Microwave assisted drying is accomplished by simultaneously using forced-air convective heating and drying to the surface of the product while at the same time exposing the product to microwave heating that forces the moisture that remains in the product to the surface whereby the convective heating and drying continues to dry the product. The convective dryer parameters are the same as discussed previously. The addition is the microwave-heating element, with the power of the microwave being adjusted dependent on the product to be dried as well as the desired final product moisture. As an example the product can be conveyed through an oven that contains a tunnel that is equipped with wave-guides to feed the microwave energy to the product and chokes designed to prevent the microwaves from leaving the oven. As the product is conveyed through the tunnel the convective and microwave heating simultaneously work to lower the moisture content of the product whereby drying. Typically, the air temperature is 50° C. to about 80° C., and the microwave power is varied dependent on the product, the time the product is in the oven, and the final moisture content desired.

The desired moisture content may vary widely depending on the intended application of the extrudate. Generally speaking, the extruded material (the structured protein product) has a moisture content of less than about 10% moisture as a further example the structured protein product may have a moisture content typically from about 5% to about 13% by weight, if dried. Although not required in order to separate the fibers, hydrating in water until the water is absorbed is one way to separate the fibers. If the structured protein product is not dried or not fully dried, its moisture content can be higher, generally from about 16% to about 30% by weight. If a structured protein product with high moisture content is produced, the structured protein product may require immediate use or refrigeration to ensure product freshness, and minimize spoilage.

The extrudate may further be comminuted to reduce the average particle size of the extrudate. Typically, the reduced extrudate has an average particle size of from about 0.1 mm to about 40.0 mm. In one example, the reduced extrudate has an average particle size of from about 5.0 mm to about 30.0 mm. In another embodiment, the reduced extrudate has an average particle size of from about 0.5 mm to about 20.0 mm. In a further embodiment, the reduced extrudate has an average particle size of from about 0.5 mm to about 15.0 mm. In an additional embodiment, the reduced extrudate has an average particle size of from about 0.75 mm to about 10.0 mm. In yet another embodiment, the reduced extrudate has an average particle size of from about 1.0 mm to about 5.0 mm. Suitable apparatuses for reducing particle size include hammer mills such as Mikro Hammer Mills manufactured by Hosokawa Micron Ltd. (England), Fitzmill® manufactured by the Fitzpatrick Company (Elmhurst, Ill.), Comitrol® processors made by Urschel Laboratories, Inc. (Valparaiso, Ind.), and roller mills such as RossKamp Roller Mills manufactured by RossKamp Champion (Waterloo, Ill.).

(e) Characterization of the Structured Protein Products

The extrudates (structured protein products) produced in I(d) above, typically comprise protein fibers that are substantially aligned. In the context of this invention “substantially aligned” generally refers to the arrangement of protein fibers such that a significantly high percentage of the protein fibers forming the structured protein product are contiguous to each other at less than approximately a 45° angle when viewed in a horizontal plane. Typically, an average of at least 55% of the protein fibers comprising the structured protein product are substantially aligned. In another embodiment, an average of at least 60% of the protein fibers comprising the structured protein product are substantially aligned. In a further embodiment, an average of at least 70% of the protein fibers comprising the structured protein product are substantially aligned. In an additional embodiment, an average of at least 80% of the protein fibers comprising the structured protein product are substantially aligned. In yet another embodiment, an average of at least 90% of the protein fibers comprising the structured protein product are substantially aligned.

Methods for determining the degree of protein fiber alignment are known in the art and include visual determinations based upon micrographic images. By way of example, FIGS. 1 and 2 depict micrographic images that illustrate the difference between a structured protein product having substantially aligned protein fibers compared to a protein product having protein fibers that are significantly crosshatched. FIG. 1 depicts a structured protein product prepared according to I (a)-I (d) having protein fibers that are substantially aligned. Contrastingly, FIG. 2 depicts a protein product containing protein fibers that are significantly crosshatched and not substantially aligned. Because the protein fibers are substantially aligned, as shown in FIG. 1, the structured protein products utilized in the invention generally have the texture and consistency of animal meat. In contrast, traditional extrudates having protein fibers that are randomly oriented or crosshatched generally have a texture that is soft or spongy.

In addition to having protein fibers that are substantially aligned, the structured protein products of the invention also typically have shear strength substantially similar to intact muscle foods. In this context of the invention, the term “shear strength” provides one means to quantify the formation of a sufficient fibrous network to impart whole-muscle like texture and appearance to the structured protein product. Shear strength is the maximum force in grams needed to shear through a given sample. A method for measuring shear strength is described in Example 9. Generally speaking, the structured protein products of the invention will have average shear strength of at least 1400 grams. In an additional embodiment, the structured protein products will have average shear strength of from about 1500 to about 1800 grams. In yet another embodiment, the structured protein products will have average shear strength of from about 1800 to about 2000 grams. In a further embodiment, the structured protein products will have average shear strength of from about 2000 to about 2600 grams. In an additional embodiment, the structured protein products will have average shear strength of at least 2200 grams. In a further embodiment, the structured protein products will have average shear strength of at least 2300 grams. In yet another embodiment, the structured protein products will have average shear strength of at least 2400 grams. In still another embodiment, the structured protein products will have average shear strength of at least 2500 grams. In a further embodiment, the structured protein products will have average shear strength of at least 2600 grams.

A means to quantify the size of the protein fibers formed and the quantity of protein fibers in the structured protein products may be done by a shred characterization test. Shred characterization is a test that generally determines the percentage of large pieces formed in the structured protein product. In an indirect manner, percentage of shred characterization provides an additional means to quantify the degree of protein fiber alignment and fiber strength in a structured protein product. Generally speaking, as the percentage of large pieces increases, the degree of protein fibers that are aligned within a structured protein product also typically increases. Conversely, as the percentage of large pieces decreases, the degree of protein fibers that are aligned within a structured protein product also typically decreases. A method for determining shred characterization is detailed in Example 10. The structured protein products of the invention typically have an average shred characterization of at least 10% by weight of large pieces. In a further embodiment, the structured protein products have an average shred characterization of from about 10% to about 20% by weight of large pieces. In another embodiment, the structured protein products have an average shred characterization of from about 20% to about 30% by weight of large pieces. In yet another embodiment, the structured protein products have an average shred characterization of from about 30% to about 40% by weight of large pieces. In yet another embodiment, the structured protein products have an average shred characterization of from about 40% to about 50% by weight large pieces. In yet another embodiment, the structured protein products have an average shred characterization of from about 50% to about 60% by weight large pieces. In yet another embodiment, the structured protein products have an average shred characterization of from about 60% to about 70% by weight large pieces. In yet another embodiment, the structured protein products have an average shred characterization of from about 70% to about 80% by weight large pieces. In yet another embodiment, the structured protein products have an average shred characterization of from about 80% to about 90% by weight large pieces. In another embodiment, the average shred characterization is at least 90% by weight, at least 91% by weight, at least 92% by weight, at least 93% by weight, at least 94% by weight, at least 95% by weight, at least 96% by weight at least 97% by weight, at least 98% by weight, at least 99% by weight or 100% by weight large pieces.

Suitable structured protein products of the invention generally have protein fibers that are substantially aligned, have average shear strength of at least 1400 grams, and have an average shred characterization of at least 10% by weight large pieces. More typically, the structured protein products will have protein fibers that are at least 55% aligned, have average shear strength of at least 1800 grams, and have an average shred characterization of at least 15% by weight large pieces. In exemplary embodiment, the structured protein products will have protein fibers that are at least 55% aligned, have average shear strength of at least 2000 grams, and have an average shred characterization of at least 17% by weight large pieces. In another exemplary embodiment, the structured protein products will have protein fibers that are at least 55% aligned, have average shear strength of at least 2200 grams, and have an average shred characterization of at least 20% by weight large pieces.

The structured protein product can be a structured vegetable protein product as described above, such as SUPRO®MAX 5050 or SUPRO®MAX 5000 (Solae, LLC, St. Louis, Mo.). The structured protein product can also be a structured vegetable protein concentrate, such as RESPONSE™ 4400 (Solae, LLC, St. Louis, Mo.) or a structured vegetable protein flour, such as CENTEX™ (Solae, LLC, St. Louis, Mo.). The structured vegetable protein product may be hydrated in order to be incorporated into various food products. Tofu can be used to hydrate the structured protein product as described in the examples that follow. Either silken tofu or firm tofu can be used. When firm tofu is used, additional water must be added to the composition in order to form the hydrated structured vegetable protein composition. The ratio of tofu:structured vegetable protein is between about 2:1 to about 6:1.

In one embodiment, a gluten-free hydrated structured soy protein composition is produced by using the structured soy protein concentrate RESPONSE™ 4400.

In another embodiment, soymilk and a coagulant are used to hydrate the structured protein product. First, soymilk is mixed with the structured protein product, then a coagulant is added to the mixture to form the hydrated structured protein composition. The coagulant can be any coagulant known in the art that would work in the application, such as calcium sulfate, magnesium chloride, potassium chloride, calcium chloride, glucono delta lactone, chitosan, alum, nigari or bittern, enzymes such as transglutaminase, papain, vinegar, lemon juice, lime juice, and mixtures thereof.

### (II) Restructured Meat Compositions and Restructured Food Compositions

The structured protein products are utilized in the invention as a component in restructured meat compositions and restructured food compositions. A restructured meat composition may comprise a mixture of animal meat and structured protein product, or it may comprise no meat and primarily structured protein product. The process for producing the restructured meat compositions generally comprises optionally mixing it with animal meat, coloring and hydrating (with tofu) the structured protein product, reducing its particle size, and further processing the composition into a food product comprising meat. A restructured food composition may comprise comminuted vegetables, comminuted fruit, or both and structured protein product.

It is well known in the art to produce mechanically deboned or separated raw meats using high-pressure machinery that separates bone from animal tissue, by first crushing bone and adhering animal tissue and then forcing the animal tissue, and not the bone, through a sieve or similar screening device. The animal tissue in the present invention comprises muscle tissue, organ tissue, connective tissue and skin. The process forms an unstructured, paste-like blend of soft animal tissue with a batter-like consistency and is commonly referred to as mechanically deboned meat or MDM. This paste-like blend has a particle size of from about 0.25 to about 15 millimeters, preferably up to about 5 millimeters and most preferably up to about 3 millimeters.

Once the meat is ground, it is not necessary to freeze it to provide cutability into individual strips or pieces. Unlike meat meal, raw meat has a natural high moisture content with a ratio of protein to moisture of from about 1:3.6 to 1:3.7.

The raw meat used in the present invention may be any edible meat suitable for consumption. The meat may be non-rendered, non-dried, raw meat, raw meat products, raw meat by-products, and mixtures thereof. The meat or meat products are comminuted and can be supplied daily in a completely frozen state, fresh unfrozen state, or fresh, unfrozen, presalted, precured state so as to avoid microbial spoilage. Generally the temperature of the comminuted meat is below about 40° C. (104° F.), preferably below about 10° C. (50° F.) more preferably is from about −4° C. (25° F.) to about 6° C. (43° F.) and most preferably from about −2° C. (28° F.) to about 2° C. (36° F.). While refrigerated or chilled meat may be used, it is generally impractical to store large quantities of unfrozen meat for extended periods of time at a plant site. The frozen products provide a longer holding duration than do the refrigerated or chilled products.

Cooked meat could be combined with the hydrated structured protein composition to form a food product. Additionally, this combination may or may not contain added ingredients such as spices, vegetables, fruits, nut meats, cereal grains, flavorings and starches. Further the food product may be retorted, oven, steam or microwave cooked. Such a food composition would contain between about 3% and about 95% cooked meat.

The restructured meat composition may optionally be blended with comminuted vegetable or comminuted fruit to produce restructured food compositions. In general, the restructured meat composition will be blended with comminuted vegetable or comminuted fruit that has a similar particle size.

A variety of vegetables or fruits are suitable for use in the restructured food composition. Typically, the amount of hydrated structured protein composition in relation to the amount of comminuted vegetable or comminuted fruit in the restructured food compositions can and will vary depending upon the composition's intended use. By way of example, the concentration of comminuted vegetable or comminuted fruit in the restructured food composition may be about 95%, 90%, 85%, 80%, 75%, 70%, 65%, 60%, 55%, 50%, 45%, 40%, 35%, 30%, 25%, 20%, 15%, 10%, 5%, 2%, or 0% by weight. Consequently, the concentration of hydrated structured plant protein composition in the restructured food composition may be about 5%, 10%, 15%, 20%, 25%, 30%, 35%, 40%, 45%, 50%, 55%, 60%, 65%, 70%, 75%, 80%, 85%, 90%, 95%, or 99% by weight. In an exemplary embodiment, the restructured food composition will generally have from about 40% to about 60% by weight of the hydrated structured protein composition and from about 40% to about 60% by weight of comminuted vegetable or comminuted fruit.

The structured protein composition may optionally be blended with comminuted vegetable or comminuted fruit to produce restructured food compositions. In general, the structured protein composition will be blended with comminuted vegetable or comminuted fruit that has a similar particle size.

A variety of vegetables or fruits are suitable for use in the restructured food composition. Typically, the amount of hydrated structured protein composition in relation to the amount of comminuted vegetable or comminuted fruit in the restructured food compositions can and will vary depending upon the composition's intended use. By way of example, the concentration of comminuted vegetable or comminuted fruit in the restructured food composition may be about 95%, 90%, 85%, 80%, 75%, 70%, 65%, 60%, 55%, 50%, 45%, 40%, 35%, 30%, 25%, 20%, 15%, 10%, 5%, 2%, or 0% by weight. Consequently, the concentration of hydrated structured plant protein composition in the restructured food composition may be about 5%, 10%, 15%, 20%, 25%, 30%, 35%, 40%, 45%, 50%, 55%, 60%, 65%, 70%, 75%, 80%, 85%, 90%, 95%, or 99% by weight. In an exemplary embodiment, the restructured food composition will generally have from about 40% to about 60% by weight of the hydrated structured protein composition and from about 40% to about 60% by weight of comminuted vegetable or comminuted fruit.

(a) Hydrating and Coloring the Structured Protein Product

The structured protein product is generally colored with a colorant so as to resemble whatever end use food product the structured protein product will be used in.

The colorant(s) may be mixed with the protein-containing material and other ingredients prior to being fed into the extruder. Alternatively, the colorant(s) may be combined with the protein-containing material and other ingredients after being fed into the extruder.

The colorant(s) may be a natural colorant, a combination of natural colorants, an artificial colorant, a combination of artificial colorants, or a combination of natural and artificial colorants. Suitable examples of natural colorants approved for use in food include annatto (reddish-orange), anthocyanins (red to blue, depending upon pH), beet juice, beta-carotene (orange), beta-APO 8 carotenal (orange), black currant, burnt sugar; canthaxanthin (pink-red), caramel, carmine/carminic acid (bright red), cochineal extract (red), curcumin (yellow-orange); lac (scarlet red), lutein (red-orange); lycopene (orange-red), mixed carotenoids (orange), monascus (red-purple, from fermented red rice), paprika, red cabbage juice, riboflavin (yellow), saffron, titanium dioxide (white), and turmeric (yellow-orange). Suitable examples of artificial colorants approved for food use in the United States include FD&C Red No. 3 (Erythrosine), FD&C Red No. 40 (Allure Red), FD&C Yellow No. 5 (Tartrazine), FD&C Yellow No. 6 (Sunset Yellow FCF), FD&C Blue No. 1 (Brilliant Blue), FD&C Blue No. 2 (Indigotine). Artificial colorants that may be used in other countries include Cl Food Red 3 (Carmoisine), Cl Food Red 7 (Ponceau 4R), Cl Food Red 9 (Amaranth), Cl Food Yellow 13 (Quinoline Yellow), and Cl Food Blue 5 (Patent Blue V). Food colorants may be dyes, which are powders, granules, or liquids that are soluble in water. Alternatively, natural and artificial food colorants may be lake colors, which are combinations of dyes and insoluble materials. Lake colors are not oil soluble, but are oil dispersible; tinting by dispersion.

Suitable colorant(s) in a variety of forms may be combined with the protein-containing materials. Non-limiting examples include dyes, lakes, dispersions, and pigments. The type and concentration of colorant(s) utilized may vary depending on the protein-containing materials used and the desired color of the colored structured protein product. Typically, the concentration of dyes, lakes, dispersions, and pigments may range from about 0.001% to about 5.0% by weight. In one embodiment, the concentration of dyes, lakes, dispersions, and pigments may range from about 0.01% to about 4.0% by weight. In another embodiment, the concentration of dyes, lakes, dispersions, and pigments may range from about 0.05% to about 3.0% by weight. In still another embodiment, the concentration of dyes, lakes, dispersions, and pigments may range from about 0.1% to about 3.0% by weight. In a further embodiment, the concentration of dyes, lakes, dispersions, and pigments may range from about 0.5% to about 2.0% by weight. In another embodiment, the concentration of dyes, lakes, dispersions, and pigments may range from about 0.75% to about 1.0% by weight.

(b) Addition of Optional Ingredients

The restructured meat compositions or food compositions may optionally include a variety of flavorings, spices, antioxidants, or other ingredients to impart a desired flavor or texture or to nutritionally enhance the final food product. As will be appreciated by a skilled artisan, the selection of ingredients added to the restructured meat composition can and will depend upon the food product to be manufactured.

### (III) Food Products

The restructured meat compositions or food compositions may be processed into a variety of food products having a variety of shapes. When the hydrated structured protein composition further comprises at least one ingredient selected from the group consisting of a gelling protein, an animal fat, sodium chloride, phosphates (sodium tripolyphosphate, sodium acid pyrophosphates, hexametaphosphate, etc.), a colorant, a curing agent, an antioxidant, an antimicrobial agent, a flavorant, or mixtures thereof, the composition and process are completed in a procedure similar to the composition and process utilizing only the hydrated structured protein composition, animal meat, comminuted vegetable, or comminuted fruit, and water. The structured protein product may first be hydrated and shredded to expose and separate the fibers. When hydration and shredding are complete, a colorant can be added. The animal meat, comminuted vegetable, or comminuted fruit, and water are added and the contents are mixed until a homogeneous mass is obtained. This can be followed by the addition of an animal fat, a flavorant, sodium chloride, phosphates, and the gelling protein. In an additional embodiment, sodium nitrite may be added along with salt and phosphates.

A vegetable composition may be prepared by a process of combining a structured protein composition, preferably a hydrated and shredded structured soy protein composition with a comminuted vegetable; and mixing the hydrated and shredded structured soy protein composition and the comminuted vegetable to produce a homogeneous, fibrous and structured vegetable product having protein fibers that are substantially aligned.

Examples of vegetable compositions include vegetarian food products such as vegetarian patties, vegetarian hot dogs, vegetarian sausages, and vegetarian crumbles. Another example of a vegetarian food product is cheese products that are extended with the hydrated and shredded protein composition.

A fruit product may be prepared by combining a protein composition, preferably a hydrated and shredded structured soy protein composition with a comminuted fruit; and mixing the hydrated and shredded structured soy protein composition and the comminuted fruit to produce a homogeneous, fibrous and structured fruit product having protein fibers that are substantially aligned.

Examples of fruit compositions include snack food products such as fruit rollups, fruit containing cereals, and fruit crumbles.

### DEFINITIONS

The terms “animal meat” or “meat” as used herein refers to the muscles, organs, and by-products thereof derived from an animal, wherein the animal may be a land animal or an aquatic animal.

The term “comminuted fruit” as used herein refers to a puree of a single fruit or a mixed fruit puree, along with ground fruit, such as one or more ground fruits.

The term “comminuted meat” as used herein refers to a meat paste that is recovered from an animal carcass. The meat, on the bone or the meat plus the bone is forced through a deboning device such that meat is separated from the bone and reduced in size. Meat that is off the bone would not be further treated with a deboning device. The meat is separated from the meat/bone mixture by forcing through a cylinder with small diameter holes. The meat acts as a liquid and is forced through the holes while the remaining bone material remains behind. The fat content of the comminuted meat may be adjusted upward by the addition of animal fat.

The term “comminuted vegetable” as used herein refers to a puree of a single vegetable or a mixed vegetable puree, along with ground vegetables, such as one or more ground vegetables.

The term “extrudate” as used herein refers to the product of extrusion. In this context, the plant protein products comprising protein fibers that are substantially aligned may be extrudates in some embodiments.

The term “fiber” as used herein refers to a plant protein product having a size of approximately 4 centimeters in length and 0.2 centimeters in width after the shred characterization test detailed in Example 10 is performed. In this context, the term “fiber” does not include the nutrient class of fibers, such as soybean cotyledon fibers, and also does not refer to the structural formation of substantially aligned protein fibers comprising the plant protein products.

The term “gluten” as used herein refers to a protein fraction in cereal grain flour, such as wheat, that possesses a high content of protein as well as unique structural and adhesive properties.

The term “gluten free starch” as used herein refers to various starch products such as modified tapioca starch. Gluten free or substantially gluten free starches are made from wheat, corn, and tapioca based starches. They are gluten free because they do not contain the gluten from wheat, oats, rye or barley.

The term “hydration test” as used herein measures the amount of time in minutes necessary to hydrate a known amount of the protein composition.

The term “large piece” as used herein is the manner in which a colored or uncolored structured plant protein product's shred percentage is characterized. The determination of shred characterization is detailed in Example 10.

The term “mechanically deboned meat (MDM)” as used herein refers to a meat paste that is recovered from beef, pork and chicken bones using commercially available equipment. MDM is a comminuted product that is devoid of the natural fibrous texture found in intact muscles.

The term “moisture content” as used herein refers to the amount of moisture in a material. The moisture content of a material can be determined by A.O.C.S. (American Oil Chemists Society) Method Ba 2a-38 (1997), which is incorporated herein by reference in its entirety.

The term “protein content,” as for example, soy protein content as used herein, refers to the relative protein content of a material as ascertained by A.O.C.S. (American Oil Chemists Society) Official Methods Bc 4-91 (1997), Aa 5-91 (1997), or Ba 4d-90 (1997), each incorporated herein by reference in their entirety, which determine the total nitrogen content of a material sample as ammonia, and the protein content as 6.25 times the total nitrogen content of the sample.

The term “protein fiber” as used herein refers to the individual continuous filaments or discrete elongated pieces of varying lengths that together define the structure of the structured vegetable protein products of the invention. Additionally, because both the colored and uncolored structured plant protein products of the invention have protein fibers that are substantially aligned, the arrangement of the protein fibers impart the texture of whole meat muscle to the colored and uncolored structured plant protein products.

The term “shear strength” as used herein measures the ability of a textured protein to form a fibrous network with a strength sufficient to impart meat-like texture and appearance to a formed food product. Shear strength is measured in grams.

The term “simulated” as used herein refers to an animal meat-like composition that contains no animal meat.

The term “soy cotyledon fiber” as used herein refers to the polysaccharide portion of soy cotyledons containing at least about 70% dietary fiber. Soy cotyledon fiber typically contains some minor amounts of soy protein, but may also comprise 100% fiber. Soy cotyledon fiber, as used herein, does not refer to, or include, soy hull fiber. Generally, soy cotyledon fiber is formed from soybeans by removing the hull and germ of the soybean, flaking or grinding the cotyledon and removing oil from the flaked or ground cotyledon, and separating the soy cotyledon fiber from the soy protein and carbohydrate materials of the cotyledon.

The term “soy protein concentrate” as used herein is a soy material having a protein content of from about 65% to less than about 90% soy protein on a moisture-free basis. Soy protein concentrate also contains soy cotyledon fiber, typically from about 3.5% up to about 20% soy cotyledon fiber by weight on a moisture-free basis. A soy protein concentrate is formed from soybeans by removing the hull and germ of the soybean, flaking or grinding the cotyledon and removing oil from the flaked or ground cotyledon, and separating the soy protein and soy cotyledon fiber from the soluble carbohydrates of the cotyledon.

The term “soy flour” as used herein, refers to full fat soy flour, enzyme-active soy flour, defatted soy flour, and mixtures thereof. Defatted soy flour refers to a comminuted form of defatted soybean material, preferably containing less than about 1% oil, formed of particles having a size such that the particles can pass through a No. 100 mesh (U.S. Standard) screen. The soy cake, chips, flakes, meal, or mixture of the material are comminuted into soy flour using conventional soy grinding processes. Soy flour has a soy protein content of about 49% to about 65% on a moisture free basis. Preferably the flour is very finely ground, most preferably so that less than about 1% of the flour is retained on a 300 mesh (U.S. Standard) screen. Full fat soy flour refers to ground whole soybeans containing all of the original oil, usually 18% to 20%. The flour may be enzyme-active or it may be heat-processed or toasted to minimize enzyme activity. Enzyme-active soy flour refers to a full fat soy flour that has been minimally heat-treat in order not to denature its natural enzymes.

The term “soy protein isolate” as used herein is a soy material having a protein content of at least about 90% soy protein on a moisture free basis. A soy protein isolate is formed from soybeans by removing the hull and germ of the soybean from the cotyledon, flaking or grinding the cotyledon and removing oil from the flaked or ground cotyledon, separating the soy protein and soluble carbohydrates of the cotyledon from the cotyledon fiber, and subsequently separating the soy protein from the soluble carbohydrates.

The term “starch” as used herein refers to starches derived from any native source. Typically sources for starch are cereals, tubers, roots, and fruits.

The term “strand” as used herein refers to a structured plant protein product having a size of approximately 2.5 to about 4 centimeters in length and greater than approximately 0.2 centimeter in width after the shred characterization test detailed in Example 10 is performed.

The term “tofu” as used herein refers to a coagulated soymilk that can be silken or firm.

The term “weight on a moisture free basis” as used herein refers to the weight of a material after it has been dried to completely remove all moisture, e.g. the moisture content of the material is 0%. Specifically, the weight on a moisture free basis of a material can be obtained by weighing the material before and after the material has been placed in a 100° C. oven until the material reaches a constant weight.

The term “wheat flour” as used herein refers to flour obtained from the milling of wheat. Generally speaking, the particle size of wheat flour is from about 14 μm to about 120 μm.

The following patents and patent applications are hereby incorporated by reference in their entirety: Ser. No. 11/437,164 disclosing the making of a structured soy protein product, Ser. No. 11/749,590 disclosing the making of a structured soy protein product, Ser. No. 11/857,876 disclosing a structured soy protein product combined with seafood and fatty acids, Ser. No. 11/852,637 disclosing a retorted fish product including structured soy protein, Ser. No. 11/868,087 disclosing modifying the texture of a structured soy protein product by adjusting pH levels, Ser. No. 11/963,375 disclosing a raw burger which includes structured soy protein and further includes a heat denaturing coloring system, Ser. No. 11/942,860 disclosing the use of a structured soy protein product in emulsified meat application Ser. No. 11/942,860 disclosing the use of a structured soy protein product in emulsified meat application Ser. No. 12/053,975 disclosing the use of a structured soy protein product in pet food and animal feed application Ser. Nos. 12/059,432 disclosing the use of structured soy protein product with fish MDM, 12/057,834 disclosing the use of structured soy protein product with cooked meat, 12/059,961 disclosing colored structured protein products.

The following examples are included to demonstrate preferred embodiments of the invention. It should be appreciated by those of skill in the art that the techniques disclosed in the examples that follow represent techniques discovered by the inventors to function well in the practice of the invention. However, those of skill in the art should, in light of the present disclosure, appreciate that many changes can be made in the specific embodiments that are disclosed and still obtain a like or similar result without departing from the spirit and scope of the invention, therefore all matter set forth or shown in the accompanying drawings is to be interpreted as illustrative and not in a limiting sense

### EXAMPLES

Examples 1-11 illustrate various embodiments of the invention.

### Example 1

Tofu is used to hydrate structured soy protein products, such as SUPRO®MAX 5050 and SUPRO®MAX 5000 (both from Solae, LLC St. Louis, Mo.) and structured soy protein concentrate, such as RESPONSE™ 4400 (Solae, LLC St. Louis Mo.). All blending is done using a Hobart mixer (Model A-200, Troy, Ohio) with the paddle attachment. The blends are not ground further and are formed into patties using a Hollymatic forming machine (Hollymatic Corporation, Countryside, Ill.). All product is cooked to 167° F. at 350° F. in a Combo Oven (Groen Combination Steamer Oven, Model CC20-E Convection Combo, Groen, Jackson, Miss.) with the convection heat and steam combination option selected. All products are then frozen for storage prior to further testing.

The tofu alone or a tofu water blend is used to hydrate the structured vegetable protein ingredients. The silken and firm tofu are from the local supermarket and are manufactured by the same company, VitaSoy USA, Inc., Ayer, Mass., under the brand name NASOYA®. The silken tofu, using all packaged contents of tofu curd and packing liquid, is liquefied using a Waring commercial blender (Model 38BL19, Torrington, Conn.) for 30 seconds on low speed and 15 seconds on high speed. This liquefied silken tofu material is then used to hydrate the various structured vegetable proteins forming the hydrated structured vegetable protein composition. The firm tofu, using all packaged content of tofu curd and packing liquid, is liquefied using a Waring blender for 30 seconds on low speed and 15 seconds on high speed. Tap water is then added to the liquefied firm tofu in a 2:1, tofu to water ratio. The liquefied firm tofu and water mixture is then blended in a Waring blender for 15 seconds on high speed. This 2:1 blend of liquefied firm tofu and water is then used to hydrate various structured vegetable proteins forming the hydrated structured vegetable protein composition.

The hydrated structured vegetable protein composition can then be combined with meat as disclosed in Examples 4-8 below or the hydrated structured vegetable protein composition can be used to make meat analogs, and other food products.

### Example 2

The structured soy protein products, such as SUPRO®MAX 5050 and SUPRO®MAX 5000 (both from Solae, LLC St. Louis, Mo.) and structured soy protein concentrate, such as RESPONSE™ 4400 (Solae, LLC St. Louis Mo.), can be hydrated with water and then be combined with tofu in a blend. All blending is done using a Hobart mixer (Model A-200, Troy, Ohio) with the paddle attachment. The blends are not ground further and are formed into patties using a Hollymatic forming machine (Hollymatic Corporation, Countryside, Ill.). All product is cooked to ° C. (167° F.) in a Combination Oven (Groen Combination Steamer Oven, Model CC20-E Convection Combo, Groen, Jackson, Miss.) set at 350° F. with the convection heat and steam combination option selected. All products are then frozen for storage prior to further testing.

The silken and firm tofu are from the local supermarket and are manufactured by the same company, VitaSoy USA, Inc., Ayer, Mass., under the brand name NASOYA®. The silken tofu, using all packaged contents of tofu curd and packing liquid, is liquefied using a Waring commercial blender (Model 38BL19, Torrington, Conn.) for 30 seconds on low speed and 15 seconds on high speed. This liquefied silken tofu material is then used in the blend with hydrated structured vegetable protein composition. The firm tofu, using all packaged content of tofu curd and packing liquid, is liquefied using a Waring blender for 30 seconds on low speed and 15 seconds on high speed. Tap water is then added to the liquefied firm tofu in a 2:1, tofu to water ratio. The liquefied firm tofu and water mixture is then blended in a Waring blender for 15 seconds on high speed. This 2:1 blend of liquefied firm tofu and water is then added to the blend with hydrated structured vegetable protein composition.

The hydrated structured vegetable protein composition and tofu blend can then be combined with meat as disclosed in Examples 4-8 below or the hydrated structured vegetable protein composition and tofu blend can be used to make meat analogs, and other food products.

### Example 3

Soymilk and a coagulant are combined with structured soy protein products, such as SUPRO®MAX 5050 and SUPRO®MAX 5000 (both from Solae, LLC St. Louis, Mo.) and structured soy protein concentrate, such as RESPONSE™ 4400 (Solae, LLC St. Louis Mo.) to form a hydrated structured vegetable protein composition. All blending is done using a Hobart mixer (Model A-200, Troy, Ohio) with the paddle attachment. The blends are not ground further and are formed into patties using a Hollymatic forming machine (Hollymatic Corporation, Countryside, Ill.). Product is cooked to 167° F. at 350° F. in a Combo Oven (Groen Combination Steamer Oven, Model CC20-E Convection Combo, Groen, Jackson, Miss.) with the convection heat and steam combination option selected. All products are then frozen for storage prior to further testing.

The soymilk is mixed with the structured soy protein. Next, a coagulant is added to the mixture of soymilk and structured soy protein forming a hydrated structured vegetable protein composition.

The hydrated structured vegetable protein composition can then be combined with meat to form various meat products or the hydrated structured vegetable protein composition can be used to make meat analogs, and other food products.

### Product Manufacturing for Examples 4-8

Use of tofu to hydrate structured soy protein products, such as SUPRO®MAX 5050 and SUPRO®MAX 5000 (both from Solae, LLC St. Louis, Mo.) and structured soy protein concentrate, such as RESPONSE™ 4400 (Solae, LLC St. Louis Mo.), was completed by using a fully cooked chicken patty model. The chicken breasts used were ground to ½″ size and then further ground to ¼″, The chicken skin used was ground to ½″ size and then further ground to ¼″, All blending was completed using a Hobart mixer (Model A-200, Troy, Ohio) with the paddle attachment. The blends were not ground further and were formed into patties using a Hollymatic forming machine (Hollymatic Corporation, Countryside, Ill.). Product was cooked to 167° F. in a Combo Oven (Groen Combination Steamer Oven, Model CC20-E Convection Combo, Groen, Jackson, Miss., 39212) set at 350° F. with the convection heat and steam combination option selected. All products were then frozen for storage prior to further sensory and physical evaluation.

The tofu alone or a tofu water blend was used to hydrate the structured vegetable proteins, instead of using the normal water hydration. The silken and firm tofu used were from the local supermarket and were manufactured by the same company, VitaSoy USA, Inc., Ayer, Mass. 01432, under the brand name NASOYA®. The silken tofu, using all packaged contents of tofu curd and packing liquid, was liquefied using a Waring commercial blender (Model 38BL19, Torrington, Conn. 06790) for 30 seconds on low speed and 15 seconds on high speed. This liquefied silken tofu material was then used to hydrate the various structured vegetable proteins. The firm tofu, using all packaged content of tofu curd and packing liquid, was liquefied using a Waring blender for 30 seconds on low speed and 15 seconds on high speed. This liquefied firm tofu then had tap water added to it in a ratio of 2:1, tofu to water ratio. The liquefied firm tofu and water mixture was then blended in a Waring blender for 15 seconds on high speed. This 2:1 blend of liquefied firm tofu and water was then used to hydrate various structured vegetable proteins and is referred to as “firm” tofu in the treatment names of this study.

There were control treatments for each structured vegetable protein type used in the experiment. These controls were hydrated with water as the structured vegetable protein is normally used.

SUPRO®MAX 5050 was used in the production of the chicken patties according to two different procedures. One created a SUPRO®MAX 5050 material that was hydrated and shredded before addition to the meat portion of the matrix and the other was SUPRO®MAX 5050 hydrated and ground before addition to the meat portion of the matrix. A detailed description of this process can be found below. Due to the differences in these procedures, these two are discussed separately and referred to a ground SUPRO®MAX 5050 or shredded SUPRO®MAX 5050.

### Example 4

TABLE 1
Formulas used to produce chicken patties with ground SUPRO ®MAX 5050.

| | Ground | Ground | Ground |
|---|---|---|---|
| | SUPRO ®MAX | SUPRO ®MAX | SUPRO ®MAX |
| | 5050 Control | 5050 Silken Tofu | 5050 Firm Tofu |
| Chicken Breast | 45.0% | 34.7% | 34.7% |
| Chicken Skin | 7.7% | 8.0% | 8.0% |
| Silken Tofu | | 40.0% | |
| Firm Tofu | | | 26.7% |
| Water for Firm Tofu | | | 13.3% |
| SUPRO ® 500E | 3.0% | 3.0% | 3.0% |
| SUPRO ®MAX 5050 | 10.0% | 10.0% | 10.0% |
| Water for SUPRO ®MAX 5050 | 30.0% | | |
| Formula Water | 2.0% | 2.0% | 2.0% |
| Salt | 1.0% | 1.0% | 1.0% |
| Sodium Tripolyphosphate | 0.3% | 0.3% | 0.3% |
| Spices | 1.0% | 1.0% | 1.0% |
| Total | 100.0% | 100.0% | 100.0% |

For the products with tofu, the liquefied tofu was added to the SUPRO®MAX 5050 the day before the experiment to hydrate the SUPRO®MAX 5050 in a static condition under vacuum in a vacuum package. The water hydrated control had water added to the SUPRO®MAX 5050 about 30 minutes before use in the formula and was held in a static condition under vacuum in a vacuum package. Each of these streams of SUPRO®MAX 5050 was then ground to ¼″ prior to use in the formulas (Table 1). For all three of the ground SUPRO®MAX 5050 treatments, the following blending procedure was used: ground chicken breast, ground chicken skin, salt, and sodium tripolyphosphate were added into the mixer bowl and mixed with the paddle for three (3) minutes. SUPRO® 500E, formula water, ground SUPRO®MAX 5050, and spices were then added and mixed another 3 minutes. The blend was then formed into patties, fully cooked and then frozen, as previously described.

### Example 5

TABLE 2
Formulas used to produce chicken patties with shredded SUPRO ®MAX 5050.

| | Shredded | Shredded | Shredded |
|---|---|---|---|
| | SUPRO ®MAX | SUPRO ®MAX | SUPRO ®MAX |
| | 5050 Control | 5050 Silken Tofu | 5050 Firm Tofu |
| Chicken Breast | 45.0% | 34.7% | 34.7% |
| Chicken Skin | 7.7% | 8.0% | 8.0% |
| Silken Tofu | | 40.0% | |
| Firm Tofu | | | 26.7% |
| Water for Firm Tofu | | | 13.3% |
| SUPRO ® 500E | 3.0% | 3.0% | 3.0% |
| SUPRO ®MAX 5050 | 10.0% | 10.0% | 10.0% |
| Water for SUPRO ®MAX 5050 | 30.0% | | |
| Formula Water | 2.0% | 2.0% | 2.0% |
| Salt | 1.0% | 1.0% | 1.0% |
| Sodium Tripolyphosphate | 0.3% | 0.3% | 0.3% |
| Spices | 1.0% | 1.0% | 1.0% |
| Total | 100.0% | 100.0% | 100.0% |

For the shredded SUPRO®MAX 5050 treatments with tofu, liquefied tofu was added to the SUPRO®MAX 5050 in the mixer bowl and allowed to soak for 25 minutes. Then the paddle on the mixer was turned on to shred and hydrate the SUPRO®MAX 5050 for 35 minutes. The shredded SUPRO®MAX 5050 control was shredded and hydrated with water in the mixer bowl while the paddle was turned on for 35 minutes. For all three of the Shredded SUPRO®MAX 5050 treatments the formulas in Table 2 were used with the following blend procedure: ground chicken breast, ground chicken skin, salt, and sodium tripolyphosphate were added into the mixer bowl which already contained the shredded SUPRO®MAX 5050 and mixed with the paddle for three (3) minutes. SUPRO® 500E, formula water, and spices were then added and mixed another 3 minutes. The blend was then formed into patties, fully cooked and then frozen, as previously described.

### Example 6

TABLE 3
Formulas used to produce chicken patties with SUPRO ®MAX 5000

| | SUPRO ®MAX | SUPRO ®MAX | SUPRO ®MAX |
|---|---|---|---|
| | 5000 Control | 5000 Silken Tofu | 5000 Firm Tofu |
| Chicken Breast | 45.0% | 34.7% | 34.7% |
| Chicken Skin | 7.7% | 8.0% | 8.0% |
| Silken Tofu | | 40.0% | |
| Firm Tofu | | | 26.7% |
| Water for Firm Tofu | | | 13.3% |
| SUPRO ® 500E | 3.0% | 3.0% | 3.0% |
| SUPRO ®MAX 5000 | 10.0% | 10.0% | 10.0% |
| Water for SUPRO ®MAX 5000 | 30.0% | | |
| Formula Water | 2.0% | 2.0% | 2.0% |
| Salt | 1.0% | 1.0% | 1.0% |
| Sodium Tripolyphosphate | 0.3% | 0.3% | 0.3% |
| Spices | 1.0% | 1.0% | 1.0% |
| Total | 100.0% | 100.0% | 100.0% |

For the SUPRO®MAX 5000 treatments with tofu, liquefied tofu was added to the SUPRO®MAX 5000 in a vacuum package and held under static vacuum hydration for 30 minutes before being used in the formulations (Table 3). The SUPRO®MAX 5000 used in the control treatment was static soaked with water for 10 minutes prior to use in the formulation. For all three of the SUPRO®MAX 5000 treatments the following blend procedure was used: ground chicken breast, ground chicken skin, salt, and sodium tripolyphosphate were added into the mixer bowl and mixed with the paddle for three (3) minutes. SUPRO® 500E, formula water, hydrated SUPRO®MAX 5000, and spices were then added and mixed another 3 minutes. The blend was then formed into patties, fully cooked and then frozen, as previously described.

### Example 7

TABLE 4
Formulas used to produce chicken patties with RESPONSE ™ 4400.

| | RESPONSE ™ | RESPONSE ™ | RESPONSE ™ |
|---|---|---|---|
| | 4400 Control | 4400 Silken Tofu | 4400 Firm Tofu |
| Chicken Breast | 45.0% | 34.7% | 34.7% |
| Chicken Skin | 7.7% | 8.0% | 8.0% |
| Silken Tofu | | 40.0% | |
| Firm Tofu | | | 26.7% |
| Water for Firm Tofu | | | 13.3% |
| SUPRO ® 500E | 3.0% | 3.0% | 3.0% |
| RESPONSE ™ 4400 | 10.0% | 10.0% | 10.0% |
| Water for RESPONSE ™ 4400 | 30.0% | | |
| Formula Water | 2.0% | 2.0% | 2.0% |
| Salt | 1.0% | 1.0% | 1.0% |
| Sodium Tripolyphosphate | 0.3% | 0.3% | 0.3% |
| Spices | 1.0% | 1.0% | 1.0% |
| Total | 100.0% | 100.0% | 100.0% |

For the RESPONSE™ 4400 treatments with tofu, liquefied tofu was added to the RESPONSE™ 4400 in a vacuum package and held in static vacuum hydration for 30 minutes prior to use in the formulas (Table 4). The control treatment of RESPONSE™ 4400 was hydrated with water by static soaking with water for 10 minutes. For all three of the RESPONSE™ 4400 treatments the following blend procedure was used: ground chicken breast, ground chicken skin, salt, and sodium tripolyphosphate were added into the mixer bowl and mixed with the paddle for three (3) minutes. SUPRO® 500E, formula water, hydrated RESPONSE™ 4400, and spices were then added and mixed another three (3) minutes. The blend was then formed into patties, fully cooked and then frozen, as previously described.

### Example 8

TABLE 5
The formula used to produce the all meat control chicken patties.

| | All Meat |
|---|---|
| | Control |
| Chicken Breast | 82.7% |
| Chicken Skin | 10.0% |
| SUPRO ® 500E | 3.0% |
| Formula Water | 2.0% |
| Salt | 1.0% |
| Sodium Tripolyphosphate | 0.3% |
| Spices | 1.0% |
| Total | 100.0% |

An all meat control product was produced to compare to the treatments which contained structured vegetable proteins. The formulation (Table 5) included the same level of SUPRO® 500E, formula water, salt, sodium tripolyphosphate, and spices as the other formulas with increased amounts of chicken breast and skin at an equivalent fat percentage of 4%+/−1%. The blend was made by the following blend procedure: ground chicken breast, ground chicken skin, salt, and sodium tripolyphosphate were added into the mixer bowl and mixed with the paddle for two (2) minutes. SUPRO® 500E, formula water, and spices were then added and mixed for another two (2) minutes. The mix time was shortened to maintain an equal meat protein extraction level to the other treatments and prevent excessive protein extraction from having an effect on the product sensory and texture attributes. The blend was then formed into patties, fully cooked and then frozen, as previously described.

### Example 9

### Determination of Shear Strength

Shear strength of a sample is measured in grams and may be determined by the following procedure. Weigh a sample of the structured protein product and place it in a heat sealable pouch and hydrate the sample with approximately three times the sample weight of room temperature tap water. Evacuate the pouch to a pressure of about 0.01 Bar and seal the pouch. Permit the sample to hydrate for about 12 to about 24 hours. Remove the hydrated sample and place it on the texture analyzer base plate oriented so that a knife from the texture analyzer will cut through the diameter of the sample. Further, the sample should be oriented under the texture analyzer knife such that the knife cuts perpendicular to the long axis of the textured piece. A suitable knife used to cut the extrudate is a model TA-45 incisor blade manufactured by Texture Technologies (USA). A suitable texture analyzer to perform this test is a model TA, TXT2 manufactured by Stable Micro Systems Ltd. (England) equipped with a 25, 50, or 100 kilogram load. Within the context of this test, shear strength is the maximum force in grams needed to shear through the sample.

### Example 10

### Determination of Shred Characterization

A procedure for determining shred characterization may be performed as follows. Weigh about 150 grams of a structured protein product using whole pieces only. Place the sample into a heat-sealable plastic bag and add about 450 grams of water at 25° C. Vacuum seal the bag at about 150 mm Hg and allow the contents to hydrate for about 60 minutes. Place the hydrated sample in the bowl of a Kitchen Aid mixer model KM14G0 equipped with a single blade paddle and mix the contents at 130 rpm for two minutes. Scrape the paddle and the sides of the bowl, returning the scrapings to the bottom of the bowl. Repeat the mixing and scraping two times. Remove about 200 g of the mixture from the bowl. Separate that mixture such that all fibers or long strands longer than 2.5 cm are segregated from the shredded mixture. Weigh the population of fibers sorted from the shredded mixture, divide this weight by the starting weight (e.g. about 200 g), and multiply this value by 100. This determines the percentage of large pieces in the sample. If the resulting value is below 15%, or above 20%, the test is complete. If the value is between 15% and 20%, then weigh out another about 200 g from the bowl, separate the fibers or long strands longer that 2.5 cm from the shredded mixture, and perform the calculations again.

### Example 11

### Production of Plant Protein Products

The following extrusion process may be used to prepare the colored structured plant protein products of the invention. Added to a dry blend mixing vessel are the following: 1000 kilograms (kg) Supro 620 (soy isolate), 440 kg wheat gluten, 171 kg wheat starch, 34 kg soy cotyledon fiber, 10 kg of xylose, 9 kg dicalcium phosphate, and 1 kg L-cysteine. The contents are mixed to form a dry blended soy protein mixture. The dry blend is then transferred to a hopper from which the dry blend is introduced into a preconditioner along with 480 kg of water to form a conditioned soy protein pre-mixture. The conditioned soy protein pre-mixture is then fed to a twin-screw extrusion apparatus at a rate of not more than 25 kg/minute. The extrusion apparatus comprises five temperature control zones, with the protein mixture being controlled to a temperature of from about 25° C. in the first zone, about 50° C. in the second zone, about 95° C. in the third zone, about 130° C. in the fourth zone, and about 150° C. in the fifth zone. The extrusion mass is subjected to a pressure of at least about 400 psig in the first zone up to about 1500 psig in the fifth zone. Water, 60 kg, is injected into the extruder barrel via one or more injection jets in communication with a heating zone. The molten extruder mass exits the extruder barrel through a die assembly consisting of a die and a back plate. As the mass flows through the die assembly the protein fibers contained within are substantially aligned with one another forming a fibrous extrudate. As the fibrous extrudate exits the die assembly, it is cut with knives and the cut mass is then dried to a moisture content of about 10% by weight.

While the invention has been explained in relation to exemplary embodiments, it is to be understood that various modifications thereof will become apparent to those skilled in the art upon reading the description. Therefore, it is to be understood that the invention disclosed herein is intended to cover such modifications as fall within the scope of the appended claims.

What is claimed is:

1. A hydrated structured vegetable protein composition comprising:
a structured vegetable protein and
tofu, wherein the tofu is mixed with the structured vegetable protein to form a hydrated structured vegetable protein composition.

2. A food product comprising the hydrated vegetable protein composition of claim 1 and a meat mixed to form a food product.

3. The hydrated structured vegetable protein composition of claim 1 further comprising water.

4. The hydrated structured vegetable protein composition of claim 1, wherein the structured vegetable protein is selected from the group consisting of structured soy protein, structured canola protein, structured corn protein, and mixtures thereof.

5. The hydrated structured vegetable protein composition of claim 4, wherein the structured vegetable protein is a structured soy protein selected from the group consisting of isolated soy protein, soy protein concentrate, soy flour, and mixtures thereof.

6. The hydrated structured vegetable protein composition of claim 1 wherein the ratio of tofu to structured vegetable protein is 4:1.

7. The food product of claim 2, wherein the meat is selected from the group consisting of poultry, beef, pork, fish, seafood, and mixtures thereof.

8. A food product comprising the hydrated structured vegetable protein composition of claim 1.

9. The hydrated structured vegetable protein composition of claim 1, wherein the tofu is selected from the group consisting of silken tofu, firm tofu, and mixtures thereof.

10. The hydrated structured vegetable protein composition of claim 9, wherein the tofu is firm tofu and the hydrated structured vegetable protein further comprises water.

11. The hydrated structured vegetable protein composition of claim 5, wherein the structured soy protein is a structured soy protein concentrate and the hydrated structured vegetable protein is gluten free.

12. A hydrated structured vegetable protein composition comprising:
(a) a structured vegetable protein.
(b) soymilk; and,
(c) a coagulant.

13. The hydrated structured vegetable protein composition of claim 12, wherein the coagulant is selected from the group consisting of calcium sulfate, magnesium sulfate, and mixtures thereof.

14. A process of making a hydrated structured vegetable protein composition comprising the steps of:
(a) mixing a structured vegetable protein with soymilk, and
(b) adding a coagulant to form a hydrated structured vegetable protein composition.

15. A hydrated structured soy protein composition comprising:
(a) a structured soy protein and
(b) tofu, wherein the tofu is mixed with the structured soy protein to form a hydrated structured soy protein composition.

16. A food product comprising the ground meat composition of claim 1.

17. The food product of claim 16, wherein the food product is formed into a patty or link.

18. The food product of claim 17, wherein the patty is a beef patty or a sausage patty.

19. The food product of claim 16, comprising a product selected from the group consisting of meat balls, meat loaf, batter-breaded products, and restructured meat products.

20. A beef patty comprising the ground meat composition of claim 12.
